(19) United States
(12) Patent Application Publication
(10) Pub. No.: US 2008/0187607 A1
(43) Pub. Date: Aug. 7, 2008

(54) SYSTEMS, METHODS AND APPARATUSES FOR EPA EXEMPT PESTICIDAL COMPOSITIONS

(75) Inventor: Steven M. BESSETTE, Brentwood, TN (US)

Correspondence Address: NIXON & VANDERHYE, PC, 901 NORTH GLEBE ROAD, 11TH FLOOR, ARLINGTON, VA, 22203, US

(73) Assignee: ECOSMART TECHNOLOGIES INC., Alpharetta, GA (US)

(21) Appl. No.: 12/024,809

(22) Filed: Feb. 1, 2008

Related U.S. Application Data
(60) Provisional application No. 60/887,770, filed on Feb. 1, 2007.

(51) Int. Cl. A01N 65/00; A01N 27/00; A01N 37/02; A01P 7/00; B05B 1/14

(52) U.S. Cl. 424/739; 514/764; 424/774; 424/725; 424/747; 514/557; 239/266

(57) ABSTRACT

The invention is directed to methods, apparatuses and EPA exempt compositions directed to producing a safe and effective chemical or biological barrier to protect human or animal subjects from insect and other nuisance pests.

### CROSS REFERENCE TO RELATED APPLICATION

This application claims the benefit of U.S. Provisional Application No. 60/887,770, filed Feb. 1, 2007, the entire disclosure of which is incorporated herein by reference.

### FIELD OF THE INVENTION

The invention relates to systems, methods and apparatuses for killing (or repelling) flying insects in an area, for example, arthropods and flies, such as mosquitoes, noseeums, blackflies, houseflies and other flying/biting insects (e.g., from the family Culicidae, using pesticidal compositions containing EPA exempt active ingredients, as further described below.

### BACKGROUND OF THE INVENTION

Use of pesticides is regulated in the United States by the Environmental Protection Agency (EPA) under authority of the Federal Insecticide, Fungicide and Rodenticide Act (FIFRA). The EPA has issued regulations set forth in 40 Code of Federal Regulations (40 C.F.R.) and those sections pertinent to pesticides are in subchapter E, sections 152 180. To protect the public, the environment, and our natural resources, pesticides for all applications must be registered, unless they contain only ingredients that are specifically “exempt” from the registration requirements of the EPA. These exceptions are updated from time to time and current lists may be obtained from the Environmental Protection Agency website, www.EPA.gov/pesticides. Products containing the exempted active ingredients and permitted inert ingredients are exempt from the registration requirements of FIFRA if contained on the above-mentioned lists. Such EPA exempt pesticide products are highly desirable due to their safety profile and lack of persistence in the environment.

Various insect pests, such as flying insects, including but not limited to arthropods (i.e. mosquitoes, noseeums), gnats and flies (house flies, black flies, horse flies, etc.) are a nuisance and may pose a health risk to humans, pets and other domesticated animals, particularly when the humans or animals are in outdoor environments. One attempt to reduce the nuisance and risk factors associated with such insect pests involves the use of various control or application means for keeping various insect pests from flying or crawling near/on, stinging, biting, harming or otherwise annoying humans, pets and other domesticated animals in exterior spaces, such as backyards, fields, otherwise out of doors, or in environments open to the outdoors.

For instance, insect repellant compositions can be used in clothing, furniture, foodstuffs, or can be used nearby humans or animals, such as in candles or sprays to repel insect pests. It is known that compositions derived from organic material, such as plant “essential oils” (e.g., oils produced from various plants & plant parts) have also been shown to have insect repellant and/or insecticide activity. Compounds isolated from plant essential oils as well as derivatives of these isolates have also been shown to have repellant or insecticidal activity. While many natural or organic based pesticidal compositions have been identified, the effective application of many of these has not been maximized. In addition to these drawbacks noted above, both naturally occurring or organic insecticide products (e.g. pyrethrins) as well as synthetic or man made chemicals (e.g. pyrethroids), act as broad spectrum, indiscriminate insecticides, which as noted below, may not be desirable. Both synthetic or natural insecticides and insect repellants can be applied directly to a subject (i.e. topical application in creams, sprays or lotions), but may also be used with a variety of application systems (sprayers) to either kill or repel insects. Depending on the nature of the active ingredient, topical application may not be desirable as it can irritate the skin of the subject and may not be cost-effective if a large surface area must be covered. Further, many applicators are not suitable for use in residential areas.

Intermittent aerosols were developed for use in timed-release devices that were plugged into electric outlets to release a small amount of insecticide at regular intervals into indoor areas. The purpose was to release a small amount of insecticide into the air to kill flies, mosquitoes, small flying moths, gnats, and to repel cockroaches. The timer would mechanically contact the aerosol actuator and release a metered dose of the insecticide to keep the area free of insects. These units were commonly installed in food processing facilities, restaurants, hotels, motels, schools, dairy barns, milk houses, canneries, breweries, and food handling establishments where sanitation alone would not prevent infestations of the listed pests and where these insects could not be tolerated. Timed-release devices are typically battery operated and thus do not require placement near an electrical outlet. Such battery operated timers may also have a built in 10 second delay, so that the person who removes and replaces the spent aerosol has time to get down the ladder and out of range before the first discharge of the new can of product. The battery operated timer/actuator mechanism can now be placed over doorways at a height of about 7 feet from the floor to allow for the proper distribution of the insecticide as a mist containing particles or droplets less than 50 microns in size.

The aerosol cans that are typically used contain an average of 6.4 ounces (181 grams) of product, enough for 30 days of 24 hour a day use. The spray duration is less than one (1) second and the spray amount is typically 55 milligrams of product discharged every 15 minutes or 27.5 milligrams of product every 7.5 minutes. The unit is designed to treat 6,000 cubic feet (CF) of space. If the area to be treated is larger than 6,000 cubic feet, then the number of units used is in relation to the 6,000 cubic foot area for a single unit. A 750 square foot area with an eight foot ceiling is a 6,000 CF volume. Typically used pesticidal compositions pyrethrum, piperonyl butoxide, MGK 264, Esbiothrin, d-trans allethrin, and/or resmethrin.

In dairy barns, horse barns, hog barns, kennels, animal holding areas, and other farm structures or buildings housing animals or poultry the use of insecticides is highly desired. Initially, insecticides were dispensed by hand held aerosol units, but permanent, pump driven systems were developed decades ago to dispense insecticides to control flies, including houseflies, stableflies, lesser houseflies, faceflies, hornflies, horseflies, gnats, and mosquitoes for a larger area. Controls/timers, pumps, reservoirs, nylon or stainless steel tubing, and spray nozzles were developed and now are utilized in automatic systems that apply a fine mist or fog (having a droplets less than 50 microns in size) at regular intervals. Applications are generally directed at the upper corners and ceiling of the treated area. The usual rate of application is one (1) ounce of diluted product per minute per 2,000 CF of space per nozzle. Timing/frequency depends upon the equipment instructions, with the caveat that food or feed must not be exposed when spraying occurs when using most traditional pesticides due to their residues. These systems have become a very successful means of controlling insect pest populations in dairy and animal areas utilizing conventional pesticides containing synthetic active ingredients, i.e., pyrethroids.

Residential mosquito misting systems are generally employed by home owners due to concerns about West Nile virus, which has led concerns about being outdoors in backyards when mosquitoes were present. As a result, existing dairy misting systems have been employed in residential settings. Such systems typically have locked reservoirs, locked control panels, and motion detectors to override a timer if movement is detected, which would indicate the presence of people or pets in the area. The conventional residential mosquito misting systems are designed to apply product to resting surfaces where mosquitoes seek harborage during non-feeding periods. Typically, female mosquitoes are actively scouting for a blood meal in the early morning and late afternoon or early evening hours. During the day, they will seek harborage in foliage of plants.

The residential mosquito misting systems are designed to be timed to discharge product from the strategically placed spray nozzles so there is a deposition of product onto foliar surfaces. Because common insecticides such as natural pyrethrins and piperonyl butoxide (PBO) do not have long residual life on foliar surfaces, applications are timed for morning and evening. The intent is not to achieve a contact spray situation with mosquitoes that are in flight. The purpose of the system is to apply a short lived residue to the potential resting surfaces and harborage areas of the mosquitoes, thus achieving control of the pests.

Outdoor residential misting systems (sometimes called “mosquito misters”) are application systems designed to spray pesticides in a fine mist of droplets 50 microns or less in order to kill mosquitoes and other insects outdoors. Misting systems include spray nozzles that are mounted around the perimeter of a home in the lawn or landscaping, or on parts of the house or fence. The spray nozzles are connected by tubing to a supply of insecticide. Some misting systems may be turned on at preset intervals using a timer. Others may be turned on using a remote controller, while others may be activated using a switch. The insecticide products most often used in outdoor residential misting systems contain pyrethrins and permethrin. These products may also contain piperonyl butoxide. Since pyrethrins and permethrin are toxic to all insects, they may undesirably kill beneficial insects such as honeybees, ladybugs, butterflies and other non-target species. In addition, permethrin is very highly toxic to fish. The currently available systems and traditional/conventional insecticides are not totally suitable for misting, as recent regulatory pressures and licensing requirements for traditional pesticides have limited their use and application in misting systems due to exposure risks, label restrictions, and chemical trespass concerns.

The typical residential misting system includes a one-third to one half horsepower pump with a flow rate of 100 to 250 gallons per hour. The lines are typically 1 inch black nylon. Copper pipes are used as a covering for free standing nozzles and they are anchored 18 inches deep in the soil. The nozzles are stainless steel mist nozzles with a flow rate of 0.84 gallons per hour. The maximum length of the line is 1,200 linear feet. The reservoirs are typically plastic with 30, 55, or up to 250 gallons capacity. The nozzle spacing is about 8 to 10 feet apart in the air and 10 to 15 feet apart in foliage. The timers are set to run 2 to 4 times per day for 30 to 60 seconds per occurrence. Typically, the unit can be activated by the homeowner to discharge prior to going out in the yard for a social event when permitted by applicable law.

Plant essential oils can be aggressive corrosive on certain system components and systems for plant essential oil pesticides should be designed accordingly. Also, the typical misting system does not have any agitation in the storage tank to maintain a stable emulsion. When using EPA exempt pesticides, the available emulsifiers and surfactants in the formulation are limited by EPA lists of approved ingredients. Therefore, emulsifiers must be designed to work with EPA exempt pesticides to maintain a stable emulsion under extreme temperatures.

The known methods for maintaining a stable emulsion and thereby delivering effective pest control products for reducing the number of flying and/or biting insects in areas occupied by people or animals are inadequate when used with EPA exempt pesticides as they do not provide effective emulsions for delivering appropriate amounts of insecticide to effect sufficient reduction of the insect/pests so as to reduce the nuisance and risk factors associated with those insect pests. Poor emulsions may also be phytotoxic to plants and flowers in the immediate area of the misting nozzles. Aggressive plant essential oils can also attack system components, causing loss of pressure and leaks in the system. There remains, therefore, a need to have an effective system of using EPA exempt pesticides that is suitable for use in different environments, particularly, in a residential environment where safety and exposure risks are significant, and/or phytotoxicity may be problematic.

### SUMMARY OF THE INVENTION

The invention is directed to systems, methods and apparatuses for killing and/or repelling flying insects, for example, arthropods and flies, such as mosquitoes, noseeums, black flies, houseflies and other flying, biting insects with pesticidal compositions containing EPA exempt active ingredients, thereby reducing the number of insect pests within a given area occupied by people or animals so as to reduce the nuisance and risk factors associated with insect pests, without, for example, damage to plants and flowers.

The invention is further directed to specifically designed systems and components that can withstand the aggressive materials used in EPA exempt pesticides, such components being made of stainless steel, brass, fluoroelastomer (e.g., Viton®), polyethylene terephthalate (PET), etc.

A misting system that may be used, for example, may have a liquid reservoir that is operably associated with a fluid pump and motor and fluid conduits to transmit a fluid pesticidal compositions, as described herein, to one or more dispersal nozzles. A controller may be used to control the droplet size, frequency and duration of pesticidal composition dispersal. An agitator device may be associated with the fluid reservoir to adequately agitate the pesticidal composition within the reservoir during or just prior to dispersal. The controller may be interconnected with a level sensor assembly to provide a graphic indication of the level of pesticidal composition remaining in the reservoir. Additionally, the misting system may be provided with a fluid pressure switch that is capable of detecting a rupture in the fluid conduit and thereby prevent further flow of fluid from the reservoir. In further aspects, the misting system may be provided with a remote control and, optionally, a remote monitoring feature that can allow improved service and maintenance for the system, as desired.

In accordance with an aspect of the invention, there is provided a system for use in decreasing the number of insects within an area to be protected, the system comprising a pump for pumping a liquid pesticide formulation from a reservoir into a transmission line and pressurizing the liquid pesticide formulation within the transmission line, the transmission line having at least one atomizing assembly operably connected to the transmission line so that when the liquid pesticide formulation is pressurized in the transmission line the liquid pesticide formulation is released from the atomizing assembly as an atomized mist.

An aspect of the invention also provides that the pump can be cycled on and off by a controller, which can be programmable.

An aspect of the invention also provides for an EPA exempt pesticidal composition to be dispensed through the system, such dispensing being exempt from certain licensing requirements and can be safely and legally controlled by the user.

In another aspect of the invention, the atomizing assembly is comprised of a nozzle adapter and an atomizing nozzle operably connected to the nozzle adapter, wherein the nozzle adapter is operably connected to the transmission line. The atomizing nozzle can have an aperture from which the liquid pesticide formulation is released under pressure as an atomized mist containing pesticide droplets or particles that are at least 50 microns. The aperture can be, without limitation, from about 0.008 to about 0.10 inches in diameter or more and all subranges therebetween.

In another exemplary embodiment of the invention, the atomized mist may comprise droplets having an average size of about 10 microns to about 50 microns. The atomized mist comprises droplets having an average size of from about 20 to about 50 microns and all subranges therebetween.

In another exemplary embodiment of the invention, the atomized mist may comprise droplets having an average size of at least about 50 microns. Preferably, the atomized mist comprises droplets having an average size of from about 50 to about 100 microns or more and all subranges therebetween.

In yet another exemplary embodiment of the invention, there is provided a stable (i.e. up to 90 days or more), single-phase atomizable pesticide liquid composition comprising an active ingredient that has been shown to have pesticide activity present in an amount of between about 0.1% to about 50% by weight/mass/volume and all subranges therebetween, optionally containing a fixative for reducing the vapor pressure of the active ingredient present in an amount of between about 0.1% to about 80% by weight/mass/volume and all subranges therebetween, an emulsifier present in an amount of between about 1% to about 50% by weight/mass/volume and all subranges therebetween, and a solvent liquid.

In yet another exemplary embodiment of the invention, the active ingredient may comprise at least one EPA exempt plant essential oil, an isolate of an essential oil, or a derivative thereof.

In accordance with the principles of the invention, an exemplary embodiment may include:

A misting system comprising: a) a fluid reservoir for containing fluid insecticide (as described herein); b) a misting nozzle for dispersal of fluid insecticide; c) a conduit for transmitting fluid insecticide from the reservoir to the nozzle; d) a pump for flowing fluid insecticide through the conduit; e) optionally an agitator having a pump for drawing outside air from an outside air inlet and into the fluid reservoir for mixing of fluid insecticide within the reservoir; f) optionally a programmable controller for selectively operating the pump and the agitator in accordance with pre-programmed control parameters; g) optionally a transmitter for transmission of selected information relating to the system to a remote monitoring location, wherein the selected information includes an indicator of a level of fluid insecticide remaining in the fluid reservoir; and h) optionally a level sensor assembly having a plurality of floating sensor assemblies located at selected levels within the reservoir, the level sensor further providing a signal to the controller indicative of the level of fluid insecticide within the reservoir.

The misting system may further comprise a pressure switch operably associated with the fluid conduit to detect a pressure drop within the conduit and stop the pump in the event such a drop is detected.

The misting system may further comprise a remote control for operation of the controller.

The misting system may further comprise a pressure switch operably associated with the fluid conduit to detect a pressure drop within the conduit; and wherein the selected information includes an indicator of low pressure within the fluid conduit.

The misting system may further comprise a global positioning system for obtaining a physical location of the system; and wherein the selected information includes information relating to a physical location of the system.

The controller may include stored programmed information identifying an owner of the system; and the selected information includes information identifying an owner of the system.

The misting system may further comprise a moisture sensor for detection of rain proximate the system, the moisture sensor being operably associated with the controller so that detection of an unsuitable weather condition will result in cancellation of a spray cycle.

It will be appreciated by a skilled artisan that the pesticidal compositions of the invention exhibit excellent pesticidal activities using two or more U.S. Food and Drug Administration approved plant essential oils that have been exempted from U.S. EPA registration, in lieu of conventional pesticides which are generally not safe for use in households and other sensitive areas, or in lieu of pesticidal compositions containing individual plant essential oils. It will also be appreciated by the skilled artisan that the pesticidal compositions of the invention provide affordable pesticidal formulations that are aesthetically acceptable for use in the systems described herein. It will also be appreciated by the skilled artisan that the pesticidal compositions of the invention unexpectedly exhibit excellent pesticidal activities, specifically knockdown and mortality, and can be formulated as water-based emulsions for use in both pressurized (e.g. an aerosol) and non-pressurized systems in lieu of conventional oil based solvent systems.

### DESCRIPTION OF THE DRAWINGS

Various objects, features and attendant advantages of the invention will become more fully appreciated and better understood when considered in conjunction with the accompanying drawings, in which like reference characters designate the same or similar parts throughout the several views.

FIG. 1 is a perspective view of a sample area encompassing an embodiment of an atomizing or misting system of the invention;

FIG. 2 is a perspective view of an exemplary fully assembled misting or atomizing nozzle assembly of the invention;

FIG. 3 is a perspective view of an exemplary fully assembled misting or atomizing nozzle assembly of the invention in operation;

FIG. 4 is a perspective view of an exemplary disassembled misting or atomizing nozzle assembly of the invention;

FIG. 5 is an expanded perspective view of an exemplary fully assembled misting or atomizing nozzle assembly of the invention attached to a fence as shown in FIG. 1;

FIG. 6 is a perspective view of an exemplary controller pump assembly and reservoir of the invention; and

FIG. 7 is an expanded perspective view of an exemplary control panel of the controller pump assembly shown in FIG. 6.

### DETAILED DESCRIPTION OF THE EXEMPLARY EMBODIMENTS

Utilizing the pesticidal compositions disclosed herein, the invention is directed to providing an area that has a reduced number of flying insects within the area by creating a zone or perimeter within which there is dispersed a liquid formulation having an active ingredient with pesticide properties. This zone or perimeter wherein there is dispersed the liquid formulation can be created by way of atomizing the liquid formulation containing the pesticide active ingredient so as to form a mist, fog or vapor. As a result, the active ingredient dispersed within the mist decreases the number of flying insect within the area. When deployed in the zone around the area, for example, insect pests, particularly flying, biting insect pests, will tend to avoid the zone and the area, which both have an increased concentration of the pesticide active ingredient dispersed therein so that the presence of such insects within the area is reduced. The methods, apparatus and compositions of the invention provide for such pest control by which the number of insect pests within the area can be reduced. In doing so, the known problems of previous pest control means may be overcome through mortality on contact and through repellency.

Pesticidal formulations of the invention may include aqueous solutions or suspensions (such as emulsifiable concentrates, emulsions, or dispersions). The formulations of the invention, which can be applied by spraying, misting, or vaporizing, to be used in the apparatus of the invention, are prepared so as to produce a single phase atomizable liquid or fluid product in which the individual components thereof do not separate or otherwise settle and may contain one of more of the following, without limitation: from about 0.1% to about 15% by weight/mass/volume of an active ingredient having pesticide properties, from about 0.2% to about 10% by weight/mass/volume of an agent for reducing the vapor pressure of the active ingredient (a “fixative”), from about 1% to about 15% by weight/mass/volume of an emulsifier (to prevent separation of solutions), from about 0.05% to about 0.2% by weight/mass/volume of suitable additives, such as an anti-microbial preservative and, as the carrier, water or another solvent liquid in which the active ingredient may be poorly soluble, have low solubility or be insoluble. It is to be understood that each of the above-recited ranges are intended to include all subranges therebetween, as well.

Examples of such compounds (i.e., plant essential oils) that may be included in the pesticidal composition of the invention include, without limitation, members selected from the group consisting of: α-pinene or β-pinene; α-campholenic aldehyde; α-citronellol; α-iso-amyl-cinnamic (e.g., amyl cinnamic aldehyde); α-pinene oxide; α-cinnamic terpinene; α-terpineol (e.g., methods. 1-methyl-4-isopropyl-1-cyclohexen-8-ol); λ-terpinene; achillea; aldehyde c16 (pure); alpha-phellandrene; amyl cinnamic aldehyde; amyl salicylate; anethole; anise; aniseed; anisic aldehyde; basil; bay; benzyl acetate; benzyl alcohol; bergamot (e.g., monardia fistulosa, monarda didyma, citrus bergamia, monarda punctata); beta-pinene; bitter orange peel; black pepper; black seed oil; borneol; calamus; camphene; camphor (e.g., camphor dextro); cananga oil (e.g., java); canola; cardamom; carnation (e.g., dianthus caryophyllus); carvacrol; carveol; cassia; castor; catnip; cedar (e.g., hinoki); cedarwood; chamomile; cineole; cinnamaldehyde; cinnamic alcohol; cinnamon (e.g., cinnamon leaf oil); cis-pinane; citral (e.g., 3,7-dimethyl-2,6-octadienal); citronella; citronellal; citronellol dextro (e.g., 3-7-dimethyl-6-octen-1-ol); citronellol; citronellyl acetate; citronellyl nitrile; citrus; citrus unshiu; clary sage; clove (e.g., eugenia caryophyllus); clove bud; coriander; corn; cotton seed; d-dihydrocarvone; decyl aldehyde; diethyl phthalate; dihydroanethole; dihydrocarveol; dihydrolinalool; dihydromyrcene; dihydromyrcenol; dihydromyrcenyl acetate; dihydroterpineol; dimethyl salicylate; dimethyloctanal; dimethyloctanol; dimethyloctanyl acetate; diphenyl oxide; dipropylene glycol; d-limonene; d-pulegone; estragole; ethyl vanillin (e.g., 3-ethoxy-4-hydrobenzaldehyde); eucalyptol (e.g., cineole); eucalyptus citriodora; eucalyptus globulus; eucalyptus; eugenol (e.g., 2-methoxy-4-allyl phenol); evening primrose; fenchol; fennel; Ferniol™; fish; florazon (e.g., 4-ethyl-α, α-dimethyl-benzenepropanal); galaxolide; garlic; geraniol (e.g., 2-trans-3,7-dimethyl-2,6-octadien-8-ol); geraniol; geraniol 60; geranium; geranyl acetate; geranyl nitrile; ginger; grapefruit; guaiacol; guaiacwood; gurjun balsam; hedione; heliotropin; herbanate (e.g., 3-(1-methyl-ethyl) bicyclo (2, 2, 1) hept-5-ene-2-carboxylic acid ethyl ester); hercolyn d; hiba; hydroxycitronellal; i-carvone; i-methyl acetate; ionone; isobutyl quinoleine (e.g., 6-secondary butyl quinoline); isobornyl acetate; isobornyl methylether; isoeugenol; isolongifolene; isosafrole; jasmine; jojoba; juniper berry; lavender; lavandin; lemongrass; lemon; lilac flower oil; lime; lime oil; limonene; linallol oxide; linallol; linalool; linalyl acetate; linseed; litsea cubeba; 1-methyl acetate; longifolene; mandarin; mentha; menthane hydroperoxide; menthol crystals; menthol laevo (e.g., 5-methyl-2-isopropyl cyclohexanol); menthol; menthone laevo (e.g., 4-isopropyl-1-methyl cyclohexan-3-one); methyl anthranilate; methyl cedryl ketone; methyl chavicol; methyl hexyl ether; methyl ionone; methyl salicylate; mineral; mint; musk ambrette; musk ketone; musk xylol; mustard (also known as allylisothio-cyanate); myrcene; neem; nerol; neryl acetate; nonyl aldehyde; nutmeg (e.g., myristica fragrans); orange (e.g., citrus aurantium dulcis); orris (e.g., iris florentina) root; para-cymene; para-hydroxy phenyl butanone crystals (e.g., 4-(4-hydroxyphenyl)-2-butanone); passion palmarosa oil (e.g., cymbopogon martini); patchouli (e.g., pogostemon cablin); p-cymene; pennyroyal; pepper; peppermint (e.g., mentha piperita); perillaldehyde; petitgrain (e.g., citrus aurantium amara); phenyl ethyl alcohol; phenyl ethyl propionate; 2-phenyl ethyl propionate; phenyl ethyl-2-methylbutyrate; pimento berry; pimento leaf; pinane hydroperoxide; pinanol; pine ester; pine needle; pine; pinene; piperonal; piperonyl acetate; piperonyl alcohol; plinol; plinyl acetate; pseudo ionone; rhodinol; rhodinyl acetate; rosalin; rose; rosemary (e.g., rosmarinus officinalis); ryu; safrole; sage; sandalwood (e.g., santalum album); sandenol; sassafras; sesame; soy; soybean; spearmint; spice; spike lavender; spirantol; starflower; tangerine; tea seed; tea tree; terpenoids (isoprenoids or terpenes); terpineol; terpinene-4-ol; terpinolene; terpinyl acetate; tert-butylcyclohexyl acetate; tetrahydrolinalool; tetrahydrolinalyl acetate; tetrahydromyrcenol; thulasi; thyme; thymol; tomato; trans-2-hexenol; trans-anethole and metabolites thereof; triethyl citrate; turmeric; turpentine; vanillin (e.g., 4-hydroxy-3-methoxy benzaldehyde); vetiver; vitalizair; white cedar; white grapefruit; wintergreen (e.g., betula oil) and the like. As these plant essential oil compounds are known and used for other uses, they may be prepared by a skilled artisan by employing known methods. For example, the synthetic form of wintergreen oil (methyl salicylate) may also be used in the embodiment. The pesticidally or insecticidally active ingredient may also include certain isolates from the above noted oils, derivatives thereof, or the synthetic equivalent thereof, including, without limitation p-menthane-3,8-diol from eucalyptus citriodora oil, nepetalactone from catnip oil, geraniol and isomers from geraniol containing oils such as geranium oil, thymol and carvacrol from thyme oil, either alone or in combination.

Exemplary pesticidal compositions that may be employed in a accordance with the principles of the invention include, without limitation, formulations containing a pesticidally acceptable carrier and a pesticidally active ingredient comprising at least one, two, three, four or more compounds selected from the group consisting of rosemary, wintergreen, lemongrass, thyme, eugenol, cinnamon, geraniol, peppermint, vanillin and sesame. Suitable pesticidal formulations that may be utilized in the systems of the invention include, without limitation, the following:

### Exemplary Formulation 1

Solvent/Emulsifier (e.g., Butyl Lactate and/or Isopropyl Myristate)
Cinnamon Oil
Clove Oil
Isopropyl Alcohol
Isopropyl Myristate
Lemongrass Oil
Peppermint Oil
Thyme Oil
Vanillin

### Exemplary Formulation 2

Solvent/Emulsifier
Cinnamon Oil
Clove Oil
Isopropyl Myristate
Lemongrass Oil
Peppermint Oil
Thyme Oil
Vanillin

### Exemplary Formulation 3

Solvent/Emulsifier
Peppermint Oil
Rosemary Oil
Vanillin
Wintergreen Oil

### Exemplary Formulation 4

Solvent/Emulsifier
Cinnamon Oil
Eugenol
Lecithin
Lemongrass Oil
Rosemary Oil
Thyme Oil
Wintergreen Oil

### Exemplary Formulation 5

Solvent/Emulsifier
Eugenol
Isopropyl Myristate
Lecithin
Mineral Oil
Phenyl Ethyl Propionate
Sodium Lauryl Sulfate
Wintergreen Oil

### Exemplary Formulation 6

Solvent/Emulsifier
Clove Oil
Lecithin
Wintergreen Oil

### Exemplary Formulation 7

Solvent/Emulsifier
Clove Oil
Lecithin
Rosemary Oil
Thyme Oil
Wintergreen Oil

### Exemplary Formulation 8

Solvent/Emulsifier
Eugenol
Lecithin
Rosemary Oil
Sodium Lauryl Sulfate
Thyme Oil
Wintergreen Oil

### Exemplary Formulation 9

Solvent/Emulsifier
Lecithin
Peppermint Oil
Rosemary Oil
Sodium Lauryl Sulfate
Vanillin
Wintergreen Oil

### Exemplary Formulation 10

Solvent/Emulsifier
Lecithin
Mineral Oil
Peppermint Oil
Rosemary Oil
Sodium Lauryl Sulfate
Vanillin
Wintergreen Oil

### Exemplary Formulation 11

Solvent/Emulsifier (e.g., Butyl Lactate and/or Isopropyl Myristate)
Cinnamon Oil
Lecithin
Lemongrass Oil
Mineral Oil
Peppermint Oil
Phenyl Ethyl Propionate
Sodium Lauryl Sulfate
Thyme Oil
Vanillin
Wintergreen Oil

### Exemplary Formulation 12

Solvent/Emulsifier (e.g., Butyl Lactate and/or Isopropyl Myristate)
Cinnamon Oil
Geraniol
Lemongrass Oil
Peppermint Oil
Phenyl Ethyl Propionate
Sesame Oil
Vanillin
Wintergreen Oil

### Exemplary Formulation 13

Solvent/Emulsifier
Cinnamon Oil
Geraniol
Lecithin
Lemongrass Oil
Mineral Oil
Peppermint Oil
Rosemary Oil
Sodium Lauryl Sulfate
Thyme Oil
Vanillin
Wintergreen Oil

### Exemplary Formulation 14

Solvent/Emulsifier
Eugenol
Glacial Acetic Acid
Hydroxypropylcellulose
Lecithin
Phenyl Ethyl Propionate
Sodium Lauryl Sulfate

### Exemplary Formulation 15

Solvent/Emulsifier
Cinnamon Oil
Eugenol
Lecithin
Lemongrass Oil
Rosemary Oil
Thyme Oil
Wintergreen Oil

### Exemplary Formulation 16

Solvent/Emulsifier
Cinnamon Oil
Geraniol
Lecithin
Lemongrass Oil
Peppermint Oil
Rosemary Oil
Sodium Lauryl Sulfate
Vanillin
Wintergreen Oil

### Exemplary Formulation 17

Solvent/Emulsifier
Lecithin
Mineral Oil
Rosemary Oil
Sodium Lauryl Sulfate
Wintergreen Oil

### Exemplary Formulation 18

Solvent/Emulsifier
Eugenol
Glacial Acetic Acid
Lecithin
Sodium Lauryl Sulfate
Wintergreen Oil

### Exemplary Formulation 19

Solvent/Emulsifier
Clove Oil
Glacial Acetic Acid
Lecithin
Wintergreen Oil

### Exemplary Formulation 20

Solvent/Emulsifier
Geraniol
Peppermint Oil
Phenyl Ethyl Propionate (PEP)
Propellant
Sesame Oil
Vanillin
Wintergreen Oil

### Exemplary Formulation 21

Solvent/Emulsifier
Peppermint Oil
Rosemary Oil
Vanillin
Wintergreen Oil

### Exemplary Formulation 22

Solvent/Emulsifier
Rosemary Oil
Wintergreen Oil

### Exemplary Formulation 23

Solvent/Emulsifier
Mineral Oil
Rosemary Oil
Wintergreen Oil
Peppermint Oil
Vanillin

Specific exemplary pesticidal formulations that may be used include, without limitation, the following (all stated concentrations below are approximate weight percent):

### Exemplary Formulation 24

Peppermint Oil—5.0%
Wintergreen Oil—5.0%
Clove Oil—0.5%
Mineral Oil—20.0%
Isopropyl Alcohol—15%
Isopropyl Myristate (Ipm)—51.0%
Inert Carrier—3.5%

### Exemplary Formulation 25

Rosemary Oil—18%
Wintergreen Oil—50%
Lemongrass Oil—2%
Cinnamon Leaf Oil—2%
Lecithin—3%
Isopropyl Myristate—25%

### Exemplary Formulation 26

Phenethyl Propionate (Pep)-5.0%
Wintergreen Oil—5.0%
Eugenol—0.5%
Mineral Oil—20.0%
Isopropyl Alcohol—15%
Isopropyl Myristate—51.0%
Inert Carrier—3.5%

### Exemplary Formulation 27

Rosemary Oil—18%
Wintergreen Oil—33%
Eugenol—10%
Thyme Oil—2%
Lemongrass Oil—2%
Cinnamon Leaf Oil—7%
Lecithin—3%
Isopropyl Myristate—25%

### Exemplary Formulation 28

Peppermint Oil—5.0%
Wintergreen Oil—5.0%
Mineral Oil—20.0%
Isopropyl Myristate—66.0%
Clove Leaf Oil—0.5%
Inert Carrier—3.5%

### Exemplary Formulation 29

Phenylethyl Propionate—5.18%
Wintergreen Oil—5.18%
Mineral Oil—20.73%
Isopropyl Myristate—68.39%
Clove Oil—0.52%

### Exemplary Formulation 30

Pep—5%
Wintergreen Oil—5.0%
Eugenol—0.5%
Mineral Oil—20.0%
Lecithin Hr-2b—0.5%
Isopropyl Myristate—48.5%
Sodium Laurel Sulfate (Stepanol Me-Dry)-0.5%
Butyl Lactate—20.0%

### Exemplary Formulation 31

Rosemary Oil—10.0%
Peppermint Oil—2.0%
Wintergreen Oil—36.0%
Vanillin—3.0%
Mineral Oil—15.0%
Pep—2.0%
Tergitol Tmn-6—2.5%
Surfactant (E.G., Igepal)-2.5%
Isopar M—27.0%

### Exemplary Formulation 32

Pep—5.0%
Wintergreen Oil—5.0%
Mineral Oil—20.0%
Isopropyl Myristate—66.0%
Eugenol—0.5%
Inert Carrier—3.5%

### Exemplary Formulation 33

Thyme Oil—0.66%
Clove Oil—2.00%
Wintergreen Oil—2.00%
Cinnamon Leaf Oil—1.0%
Inert Carrier—94.34%

### Exemplary Formulation 34

Rosemary Oil—10.0%
Peppermint Oil—2.0%
Wintergreen Oil—45.0%
Vanillin—3.0%
Mineral Oil—15.0%
Surfactant (E.G., Igepal Ca-630+Tergitol Tmn-6)-5%
Isopar M—20.0%

### Exemplary Formulation 35

Rosemary Oil—10.0%
Peppermint Oil—2.0%
Wintergreen Oil—36.0%
Vanillin—3.0%
Mineral Oil—15.0%
Pep—2.0%
Piperonal—2.0%
Surfactant (E.G., Igepal Ca-630+Tergitol Tmn-6)-5%
Isopar M—25.0%

### Exemplary Formulation 36

Rosemary Oil—10%
Wintergreen Oil 45%
Mineral Oil—40%
Peppermint Oil—2%
Vanillin—3%

### Exemplary Formulation 37

Rosemary Oil—5%
Wintergreen Oil 22.5%
Mineral Oil—16.5%
Peppermint Oil—4.5%
Vanillin—1.5%
Lecithin—0.5%
Water—46.5%
Inert Carrier—3.0%

### Exemplary Formulation 38

Rosemary Oil—1.0%
Peppermint Oil—3.0%
Geraniol—0.5%
Lemongrass Oil—2.5%
Citronella Oil—1.5%
Thyme Oil—1.0%
Eugenol—0.5%
Mineral Oil—90.0%

### Exemplary Formulation 39

Rosemary Oil—10.0%
Peppermint Oil—30.0%
Geraniol—5.0%
Lemongrass Oil—25.0%
Citronella Oil—15.0%
Thyme Oil—10.0%
Eugenol—5.0%

### Exemplary Formulation 40

Rosemary Oil—1.0%
Wintergreen Oil—4.5%
Mineral Oil—94.0%
Lemongrass Oil—0.5%

### Exemplary Formulation 41

Rosemary Oil—0.1%
Wintergreen Oil—0.45%
Mineral Oil—99.4%
Lemongrass Oil—0.05%

### Exemplary Formulation 42

Rosemary Oil—0.1%
Wintergreen Oil—0.45%
Mineral Oil—99.33%
Peppermint Oil—0.09%
Vanillin—0.03%

### Exemplary Formulation 43

Thyme Oil—0.66%
Eugenol—3.00%
Wintergreen Oil—2.00%
Lemongrass Oil—0.40%
Inert Carrier—93.94%

### Exemplary Formulation 44

Rosemary Oil—10.0%
Wintergreen Oil—45.0%
Mineral Oil—40.0%
Lemongrass Oil—5%

### Exemplary Formulation 45

Rosemary Oil—10%
Wintergreen Oil 45%
Mineral Oil—33%
Peppermint Oil—9%
Vanillin—3%

The invention provides an effective means of insect pest control, without having deleterious effects on people, pets or the environment. The liquid pesticidal formulation disclosed herein may employ natural or organic pesticides as an active ingredient. While it may be desirable to kill insect pests as some insect pests may represent a nuisance or risk to animal or human health, the indiscriminant or overuse of insecticides and or pesticides may also kill beneficial insects and thus may be considered environmentally unsound, particularly in residential environments. As an example of this, dragonflies are generally not considered to be insect pests. Dragonflies breed, however, in habitats, such as wetlands, in which other insect pests, such as mosquitoes, also breed. Application of insecticides, pesticides or other toxins that kill mosquitoes can also harm or kill dragonflies. The resulting damage to the dragonfly population results in an increase in the population of their natural prey, such as insect pests such as mosquitoes. This in turn may lead to increases in the spread of diseases borne by the insect pests. As a result, there has been a movement away from the use of insecticides, pesticides and other toxins, synthetic or natural, that indiscriminately kill all insects, towards natural or organic compositions or formulations that kill insects. By combining an pesticide liquid formulation of the invention and a system, the active ingredient is atomized and dispersed through a spray, mist/fog, or vapor, the problems of prior art pest control methods and apparatus may be overcome.

Atomizing or misting systems are commonly used wherever it is desirable to produce droplets of a liquid or a liquid solution in the form of a spray, mist, fog or vapor. Atomizing or misting systems have been used in connection with different applications. For example, one application of such systems is to provide a mechanism whereby a subject can be cooled off or refreshed when outdoor temperatures exceed a comfortable or desired level. Other atomizing or misting systems have also been more generally used for climate control (e.g. temperature and humidity), such as in greenhouse applications, as well as in frost prevention, air filtration, fire and smoke prevention, etc.

Typically, in an atomizing or misting system, a fluid or liquid, such as water, is fed under pressure through tubing to one or more atomizer or nozzle assemblies that emit appropriately sized droplets of the fluid or liquid so as to produce a mist, fog or cloud of a desired configuration and composition. In the case of an atomizing or misting system in which the object is to cool a subject, the mist produced can be at or adjacent to where the subject is located. The fluid is typically fed into the atomizing or misting system from a reservoir located remotely from the atomizer or nozzle assemblies by a motorized pump. The motorized pump can be controlled by a controller, which may be programmable, so as to regulate the production of the mist, cloud or fog.

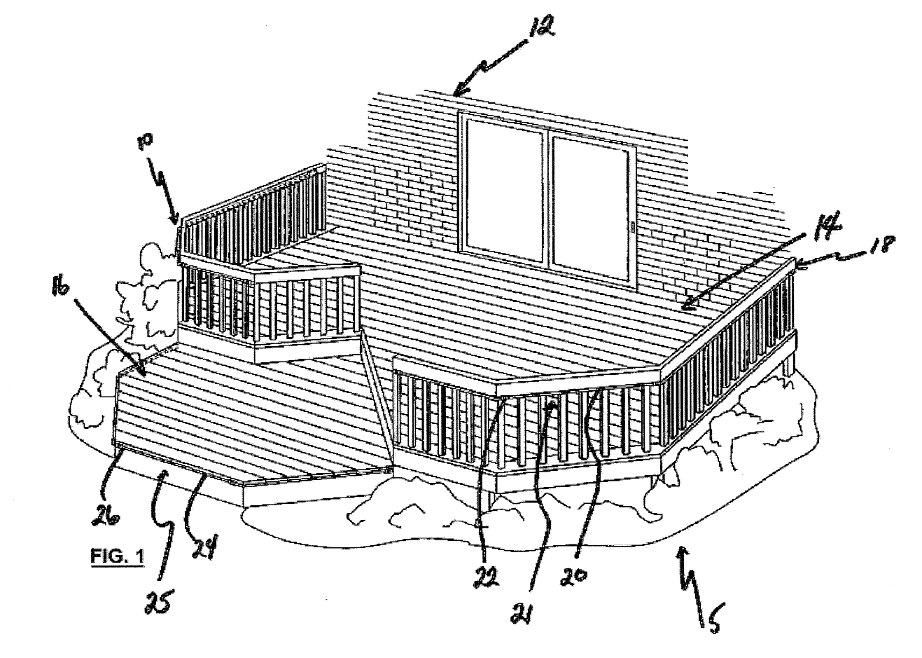

As shown in FIG. 1, yard 5 is shown, in which the misting or atomizing system 10 of the invention can be used. As shown in FIG. 1, yard 5 can be adjacent to house 12, but it will be understood that the misting or atomizing system 10 of the invention could be used in any area that requires pest control, such as commercial facilities or in animal health, and does not need to be used in a residential area, such as that illustrated in FIG. 1. However, for the purposes of illustration, a residential area will be shown. Yard 5 has first deck portion 14 and a second deck portion 16. First deck portion 14 has encompassing most of its perimeter a fence or railing portion 18. Attached to railing 18 of first deck portion 14 is a first set of tubing 20 interconnecting a plurality of atomizing or misting nozzles apparatus 22. Attached to the outer edge of second deck portion 16 is a second set of tubing 24 interconnecting a plurality of atomizing or misting nozzles apparatus 26. The misting or atomizing system 10 consists of a plurality of misting or atomizing outlets or assemblies 22 and 26 that are serially connected by the first and second sets of tubing 20 and 24, the tubing 20 and 24 forming transmission lines 21 and 25. Each of transmission lines 21 and 25 has a beginning and an end and may be interconnected. Each of transmission lines 21 and 25 can be controlled by a single controller or can each be separately connected to and controlled by a separate controller. It will be understood that if transmission lines 21 and 25 are interconnected then only a single transmission line will be required or created. It will also be understood that atomizing or misting nozzles apparatus 22 and 26 can be the same or different configuration, except that they function within the parameters outlined herein for the misting or atomizing system 10 of the invention.

For the present specification, only reference to the first set of tubing 20, atomizing or misting nozzles apparatus 22 and transmission line 21 will be used. Misting or atomizing system 10 can be designed for functioning within a pumping pressure range from 150 to 1000 psi. As noted below, the greater the pressure the smaller the droplet size will be produced from atomizing or misting nozzles apparatus 22. As such, a skilled artisan could readily adjust the pressure to obtain an desired droplet size. As such, tubing 20 (as well as tubing 24) can be either high or mid pressure tubing depending on the desired operating pressure in which the invention is to be subjected. An example of mid pressure tubing (pressure range 0 to 450 psi) that can be used in the invention is Nylon 11 or 12 (¼″ OD by 0.035″ wall thickness) commercially available from Parker Hannifin, IMI Norgren Inc., or Nycoil, Inc. Examples of high-pressure tubing (pressure range 0 to 1200 psi) that can be used in the invention can be copper or stainless steel tubing (¼″ OD) commercially available from a number of manufacturers. Transmission line 21 connects the misting or atomizing outlets or assemblies 22 to the discharge port of the controller 10 for transmission of a fluid contained within the systems reservoir.

As shown in FIG. 1, the transmission lines 21 and 25 are configured to generally enclose first deck portion 14 and second deck portion 16. In the case of the residential area shown in FIG. 1, the human users or subjects wish to be secured or protected from intrusion by pests, such as flying insects, within first deck portion 14 and second deck portion 16. Transmission line 21 and 25 generally form a perimeter or border encompassing the area of deck portions 14 and 16 to be secured or protected. The surface area of the secured or protected area in the exemplary embodiment would be the combined surface area of deck portions 14 and 16. The outer circumference of the area to be secured, namely the outer circumference of deck portions 14 and 16 would generally determine the length of the tubing 20 and 24 required for transmission lines 21 and 25. However, it will be understood that adjustments could be made thereto to accommodate the general layout and circumference of any deck portion or any other area to be protected.

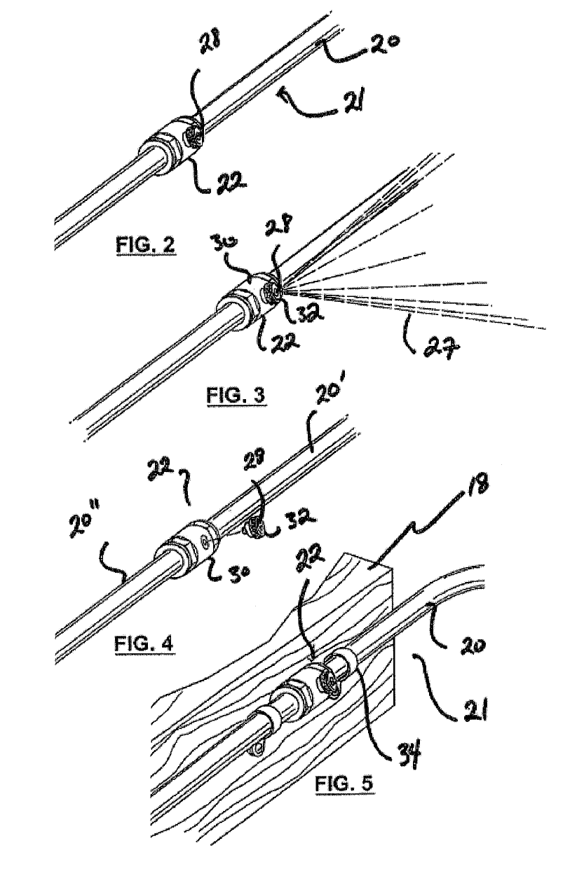

A misting or atomizing outlet or assembly 22 is shown in FIGS. 2 to 5. In operation, the EPA exempt pesticide liquid formulation or composition of the invention, in combination with appropriate emulsifiers, can be pumped under pressure through transmission line 21 to each of the misting or atomizing outlets or assemblies 22. Each of the misting or atomizing outlets or assemblies 22 is provided with an exit or egression point 28 so that, in operation as shown in FIG. 3, the pressurized pesticide liquid formulation within transmission line 21 can exit the assembly 22 in such a manner so as to create a mist or fog 27. When the misting or atomizing system 10 is activated, each of the misting or atomizing nozzle assemblies 22 will dispense droplets of the pesticide liquid formulation so as to form a mist/fog 27 in a generally inverted cone pattern as shown in FIG. 3. As noted above, the greater the pressure within transmission line 21, the smaller the droplet size.

In operation, the misting or atomizing nozzle assemblies 22 dispense a mist/fog 27 having a spray angle alpha. of between 55 and 75, more preferably between 55 and 70 or between 65 and 75. When the liquid formulation of the invention is released through the misting or atomizing nozzle assemblies 22, droplets are formed so as to create mist/fog 27. The atomized droplets of the pesticide liquid formulation tend to be heavier than air and, as a result, settle or sink towards the ground. While doing so, the active ingredient is released into the atmosphere, increasing the concentration of the active ingredient in an area surrounding atomizing nozzle assemblies 22. As the atomized droplets of the liquid formulation settle or sink towards the ground, the active ingredient will continue to be released into the environment. When all of the atomizing nozzle assemblies 22 produce a cloud or mist 27, the overlapping clouds tend to form a zone or perimeter in which the active ingredient is dispersed or atomized, this creating a zone or perimeter of increased concentration of the active ingredients. The atomized active ingredient will gradually disperse throughout the area to be protected. This will act to kill or repel away insects from the area enclosed by the zone or perimeter and will thus reduce the number of insects therein. As a result, the increased concentration of the active ingredient within and generally surrounding areas 14 and 16 will tend to kill and repel insects from areas 14 and 16. The controller repeatedly activates system to dispense mist on timed intervals thus replenishing the concentration of the active ingredient within and generally surrounding areas 14 and 16.

Upon activation of the system 10, a plurality of mist/fog 27 will be produced along the transmission line 21 at each of the misting or atomizing outlets or assemblies 22. As a result, a plurality of such mist will be produced along the perimeter of the deck portions 14 and 16. An area of increased concentration of pesticide will generally be provided along the perimeter of the deck portions 14 and 16. As noted above, the active ingredient will disperse along the deck portions so that insect pests, particularly flying insects, will tend to avoid deck portions 14 and 16. As the system 10 surrounds the deck portions, the concentration of the active ingredient will generally be higher within the deck portions than outside the deck portions. As a result, the number of insects in or around the deck portions 14 and 16 will be reduced relative to the number outside of the deck portions. People in or around deck portions 14 and/or 16, therefore, will then experience a reduction in the nuisance associate with the insect pests.

The spacing of the misting or atomizing outlets or assemblies 22 along transmission line 21 can be varied to achieve the desired protection from insect pests. For most applications, a spacing of between approximately 10 to 20 feet between each misting or atomizing outlets or assemblies 22 along transmission line 21 can be used to secure and protect the desired area. Further, depending on the level of pest control that is required greater or lesser spacing can be employed. Areas of greater pest infestation may require the placement of misting or atomizing outlets or assemblies 22 closer together (i.e. less than 10 feet between each misting or atomizing outlets or assemblies 22), while areas of lesser pest infestation may produce sufficient barrier effects with placement of misting or atomizing outlets or assemblies farther apart (i.e. greater than 20 feet between each misting or atomizing outlets or assemblies 22). In other words, the number and/or spacing of misting or atomizing outlets or assemblies 22 can be varied, depending on the size of area to be protected and secured, the environmental conditions (e.g. average wind speed, temperature during use, etc. Environmental factors such as wind and rain may determine when the controller will activate the system. For example, if it is raining, the system may not be activated. If it is windy the frequency of activation may increase or decrease depending on the area being treated (i.e. residential vs. commercial). Environmental factors that affect flying insect populations may result in a direct correlation to the usage, frequency of application of the system and the desired concentration of the solution.

Mist or atomizer nozzle assemblies 22 of the type that may be used in the invention are well known. Examples of such assemblies are those sold by Arizona Mist, Fogco Inc. and others. In an exemplary embodiment shown in FIGS. 2 to 4, a mist or atomizer nozzle assembly 22 is provided and comprises a nozzle adapter 30, as shown in FIG. 4, designed to functionally connect the two individual sets of tubing 20, tubing 20′ and 20″, of the transmission line 21 and receive the atomizing nozzle 32. As shown in FIG. 3, an atomizing or misting nozzle 32 is in operative connection with the nozzle adapter 30 so that fluid under pressure within the tubing 20 of the transmission line 21 can exit from egression or exit aperture 28 upon activation of the system 10. As shown in FIG. 4, the atomizing or misting nozzle 32 can be removable from nozzle adapter 30, for cleaning, replacement, etc., without disassembling the entire system 10 or disconnecting the sets of tubing 22 from the nozzle adapter 30. As shown in FIG. 5, the mist or atomizer nozzle assemblies 22 is attached to railing 18 by way of tubing clamps 34. The mist or atomizer nozzle assembly 22 preferably is designed to produce a mist/fog 27 having fluid droplets of from 2 to 100 microns, and all subranges therebetween to achieve the effective dispersion. Depending on the area being treated, the desired particle size of dispersed droplets of pesticidal composition may vary. For example, in residential areas, larger particles may be employed to maximize contact with the harborage areas in the foliage and minimize drift and related exposure risks, In commercial facilities, smaller particles may be employed to obtain greater coverage of a treated area. The mist or atomizer nozzle assemblies 22 may be suitable for producing a mist/fog having an inverted cone or full cone pattern wherein the widest portion of the cone having a diameter of between approximately 10 feet and approximately 20 feet. The exemplary size of the egression or exit aperture 28 is from about 0.008 to 0.12 inches in diameter and all subranges therebetween.

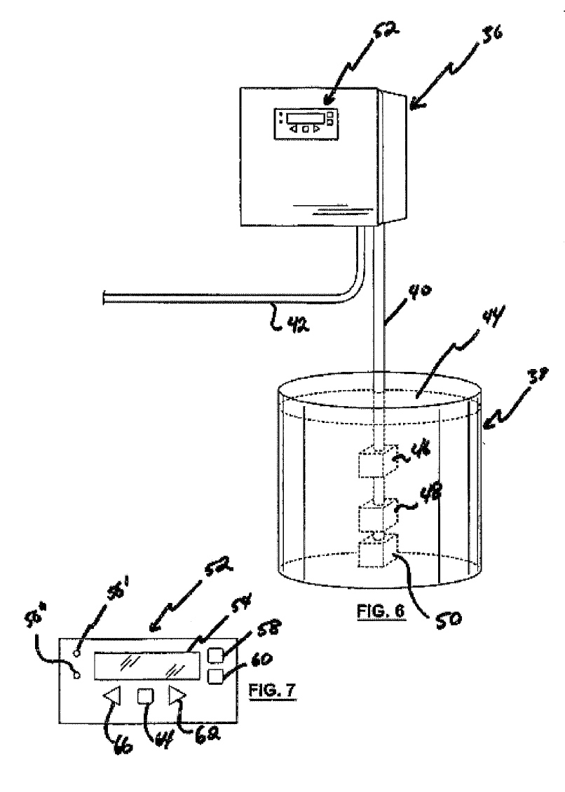

FIG. 6 shows a controller pump assembly 36 connected to reservoir 38 by way of tubing 40. As shown in FIG. 6, there is also provided tubing 42 which connects the controller-pump assembly to transmission lines 21. The controller-pump assembly 36 provides for the activation of the system 10 based on either preset commands or user specified criteria by way of a controller (not shown). Controller pump assembly 36 contains a pump (not shown) to provide the pressure by which the liquid formulation 44 of the invention is transmitted from the reservoir 38, through the tubing 40 to the controller-pump assembly 36, through tubing 42 to the transmission line 21 and to the mist or atomizer nozzle assemblies 22. Typical pumps include dynamic or centrifugal pumps (e.g. radial flow, mixed flow, axial flow, etc.) as well as positive displacement pumps (e.g. single rotor vane, piston, flexible member, duplex and triplex plunger, single crew, etc.) or multiple rotors (gear, lobe, circumferential piston, multiple screw, etc.). The pump provides for the liquid formulation 44 of the invention to be pumped at pre-selected or predetermined pressures through the transmission line 21 to the misting or atomizing outlets or assemblies 22. Pumping rates range from 2.74 to 4.93 litres/hour within an operating pressure range of 150 to 1200 psi respectively.

As shown in FIG. 6, the supply inlet of the controller pump assembly 36 is adjustably connected to an outlet of a supply or reservoir 38 containing the liquid formulation 44 of the invention by way of the supply inlet tubing 40, while a transmission outlet is adjustably connected to the transmission line 21 of the misting system by way of the transmission outlet tubing 42. The supply inlet tubing 40 is operatively connected to the reservoir 38 so as to allow the liquid formulation 44 of the invention to be pumped under pressure from the reservoir 38 into the transmission lines 21 via the supply inlet tubing 40 and the transmission outlet tubing 42. In an exemplary embodiment, the supply inlet tubing 40 may be weighted down in the reservoir by weights 46 and 48. It will be understood that while two weights are shown in FIG. 6, either one weight or any combination of weights may be used so as to achieve the operable contact of inlet supply tube 40 with the liquid formulation of the invention 44. A valve, such as a “foot-valve strainer” 50, is functionally attached to the end of the supply inlet tubing 40 that is located within the reservoir 38 and is operatively connected to the liquid formulation of the invention. The opposite end of the supply inlet tubing 40 is connected to the controller pump assembly 36 so that when the pump is activated by the controller, the liquid formulation 44 is transferred or pumped from the reservoir 38 to the transmission line 21 and ultimately through the mister or atomizer assemblies 22.

An auto drain valve assembly can be connected to the transmission outlet tubing 42 to prevent dripping of the liquid formulation from misting nozzles 32 as caused by residual pressure in tubing following pump shut down. Auto drain valve assembly is designed to open at pressures below 70 psi to release pressure in outlet tubing 42 on pump shut down and drain residual solution from tubing to reservoir 38 (not shown).

Upon activation of the pump by the controller, the liquid formulation of the invention is pumped under pressure from the supply or reservoir via the supply inlet into the transmission line via the transmission outlet into the transmission line of tubing serially connecting the misting or atomizing outlets or assemblies. The fluid solution is then released into the surrounding environment as a mist/fog adjacent to the perimeter or border encompassing the area to be secured or protected, thus creating a barrier encompassing the area to be secured or protected. Due to the composition of the misted liquid formulation, insect pests in the immediate area (e.g., within about 5 to about 15 feet of nozzles) are killed on contact while others are prevented from entering the area to be protected or secured.

The pump is controlled by a controller, which may be programmable, whereby the controller, based on either pre-determined parameters or parameters programmed by a user, controls the flow of the fluid solution of the invention through the transmission line and ultimately the misting or atomizing outlets or assemblies. It will be understood that the controller and pump can be the same apparatus, as outlined above as the controller-pump assembly 36. While preferably the controller-pump assembly is contained within a single item or apparatus, it will also be understood that the controller and the pump need not be contained in the same apparatus.

In one embodiment, the user can safely and legally control the frequency of the activation of the misting or atomizing system of the invention. In addition, wind, rain, low level tank sensors, such as those manufactured by Omron Corporation, Intermatic, Inc., etc. can be provided. In an exemplary embodiment, input 52 typically has a user interface, as shown in FIGS. 6 and 7, so as to allow a user to program the conditions under which the liquid formulation will be released through the misting or atomizing outlets or assemblies. In an exemplary embodiment shown in FIG. 7, the user interface may consist of a 2 by 16 character liquid crystal display (“LCD”) 56, 2 light emitting diodes (“LED”), 56′ and 56″, and user input buttons 58 to 66. It will be understood that any configuration which allows a user to easily program the controller-pump assembly could be used. Such user controlled units are not practical in many cases unless EPA exempt plant essential oils are utilized, such as those described in herein.

In the exemplary embodiment provided in FIG. 7, LCD display 56 is used to display the status of the atomizing system and the necessary information required during use. As seen in FIG. 7, each of LED 56′ and/or 56″ can be used to indicate “POWER ON/OFF”, 56′ which indicates whether the atomizing system is on or off and “SPRAY”, 56″ which indicates the status of the pump (i.e. whether the pump has been activated by the controller). As provided in FIG. 7, the buttons 58 to 66 can be used for various functions such as, “POWER” 58 (used to turn the controller, which in turn controls the atomizing system, power on and off), “MANUAL” 60 (used to manually operate the pump and as a master exit button from the setup menus), “MODE” 64 (used to enter and scroll through the setup menus), “ ” 66 (used to scroll through the setup menus and adjust down the selected setup menu item), and “ ”62 (used to scroll through the setup menus and adjust up the selected setup menu item).

The user may choose to either program the controller to operate under a pre-programmed set of conditions or may chose to operate the controller manually. In an exemplary embodiment, the user may choose to safely and legally program the controller. Several parameters may be controlled such as the date on which the controller/pump assembly, also known as “events”, can be activated, the time on which the controller/pump assembly can be activated, the pump & motor duty cycle, namely the rate of cycling between off and on which in other words is when the controller/pump assembly causes a mist, spray, fog etc. to be released from the nozzle assembly, or any combination thereof. Each event consists of an “ON TIME”, preferably 20 sec. and an “OFF TIME”, preferably 10 min. A person skilled in the art will understand that different programming is possible, such as for example, each day of the week can have a series of ON Times and OFF Times which are different from other days of the week. Alternatively, Monday through Friday may have the same schedule of events while Saturday and Sunday could have the same schedule of events but different from the schedule of events from each of Monday through Friday. It will be understood, therefore, that almost an infinite schedules of events could be possible. However, only EPA exempt plant essential oils in combination with specifically designed emulsifiers will allow such flexibility in most cases due to regulatory, licensing and other concerns.

In an exemplary embodiment, the pump can be manually operated to turn on for a pre-set 30-second interval by pressing and releasing the ‘MANUAL’ button 60. The manual button 60 is operational only when the system is in the off state. When the Manual button 60 is pressed the LCD 54 displays ‘Manual: ss’ indicating that the controller-pump assembly is in manual mode and a countdown timer displaying the time remaining in manual mode. When the countdown reaches zero the manual operation ends and the controller/pump assembly cycles to an OFF time. In an exemplary embodiment, a backlit LED display may be illuminated during manual operation to indicate that the controller/pump assembly has cycled to an ON Time.

Misting or atomizing outlets or assemblies 22 can be mounted to the tubing 21 by cutting the tubing, inserting the two cut ends of the tubing into each side of the nozzle adapter 30 and hand tightening the nozzle 32 into the nozzle adapter 30. In an exemplary embodiment, misting or atomizing outlets or assemblies 22 should be installed at 45 degrees upward angle from horizontal, as shown in FIGS. 2 to 5 to achieve optimal mist/fog formation and formulation dispersion, as shown in FIG. 3. However, it will be understood that any configuration of misting or atomizing outlets or assemblies that produces the desired mist/fog formation and formulation dispersion as noted above and as required by the invention would be encompassed.

The spacing of the misting or atomizing outlets or assemblies can be varied in different sections to achieve greater misting benefits in critical areas. Typically one controller/pump assembly may be capable of powering up to 50 misting or atomizing outlets or assemblies over a linear distance of approximately 1,000 feet or more. For most applications, an average misting or atomizing outlets or assemblies spacing of between approximately 10 to 20 feet can be used for effective coverage over linear areas (i.e. fence lines). However, depending on the level of pest control that is required less or more can be used. Number and spacing of nozzles varies according to area to be treated. Spacing is typically 10 to 20 feet The timing between bursts and the duration of the burst can be determined by the user to select the optional level of bug killance. Typically, the controller/pump assembly controls the timing between bursts to within 5 to 20 minutes, preferably 5 to 15 minutes and still preferably 10 minutes. The controller pump assembly also allows for a duration of misting of between 5 to 30 seconds, preferably between 10 to 25 seconds, more preferably 20 seconds.

The fluid formulation of the invention is an EPA exempt pesticide formulation that is formulated to produce a stable, single-phase atomizable liquid for use in mid-pressure pumping atomization systems, such as the one disclosed herein, when diluted with water. The fluid solution of the invention can be supplied as a concentrate, which can be then diluted on site, when mixed with appropriate emulsifiers such as those described herein.

The pesticide liquid formulation may comprise an active ingredient that has been shown to have pesticide activity present in an amount of between about 0.1% to about 50% by weight/mass/volume and all subranges therebetween. The pesticide liquid formulation may also comprise a fixative for reducing the vapor pressure of the active ingredient present in an amount of between about 0.2% to about 10% by weight/mass/volume and all subranges therebetween, an emulsifier present in an amount of between about 1% to 15% and all subranges therebetween, and a solvent liquid.

The active ingredient may comprise a plant essential oil, an isolate of an essential oil, a derivative thereof, or a synthetic equivalent thereof, either alone or in combination. For example, the essential oils can include those oils described above, including certain isolates from the above noted oils, derivatives thereof, or the synthetic equivalent thereof.

Non-active ingredients (pesticidally acceptable carriers) such as emulsifiers are required with EPA exempt pesticides. These emulsifiers may include for example, polysorbate 20 and other similar grade emulsifiers of identical or generally similar hydrophobic-lypophobic balance and may be include mono-glyceride derivatives, poly-oxyethylene nonyl phenolethers, and sugars esters and sodium lauryl sulfate (SLS), butyl lactate, isopropyl myristate (and analogs thereof); emulsifiers in the class polyoxyethylene condensation products with derivatives of sorbitol, lecithin of various origins such as soy and egg yolk. Further emulsifiers that may be employed include, without limitation, one of, or blends of two or more of: sorbitan monooleate; benzyl alcohol; tergitol; sodium alkyl ether sulfate; and the like.

By way of example, and not intending to be limited hereby, the invention will be further exemplified below. The following Example are illustrative of various embodiments only and do not limit the claimed invention regarding the materials, conditions, weight ratios, process parameters and the like recited herein.

### Example 1

### Species Tested

The yellow fever mosquito, Aedes aegypti.

### Materials and Methods:

“Bugs Away” pesticide sprayer/mister (6′×6′×12′ screen cage/chamber) (GAR 747 210 343).
A screened cage from BioQuip (6′×6′×12′) with an aluminum frame was used as the basic spray chamber. Polyethylene sheeting was hung on the inside walls and ceiling of the chamber, affixed to the frame by wires. The polyethylene sheeting collected excess misted insecticides and can be replaced with clean polyethylene when needed.
The temperature in the chamber was 25° C.±20.
Adult mosquitoes were anesthetized with carbon dioxide; ten mosquitoes were placed into each of three wire-mesh cages, 4″×4″×6″, which were suspended in the far end of the spray chamber by wires. They were hung at 4′ above the floor and 10′ away from the misting device, in the center of the far end of the chamber.
The sprayer/mister was positioned near the open end of the spray chamber. Only one of the misting nozzles was employed, pointed toward the far end of the cage.
The tested formulation contained eugenol, phenethyl propionate in isopropyl myristate.
The sprayer/mister on for its automatic 40-second spray cycle.
Knockdown and mortality were recorded at 5 min., 30 min., 1 hr. and 2 hr. “Knockdown” was recorded for insects that were not able to stand or fly, but were still moving. “Mortality” was recorded for insects that were prone and motionless.
“Control” treatment consists of misting the insects with only the carrier solvent.
The same placement of cage and times for recording knockdown and mortality can be used for flies.
Three replicate cages of mosquitoes are used. Percentage knockdown and percentage mortality is reported below for all three replicates. The mean of the percentage mortality is calculated for the treatment, ±S.E. and is reported in the table below.
Coated glass microscope slides are obtained so that droplets can be collected at the 10-foot distance.

### Results

Misting efficacy of formulation of eugenol (0.5%)+PEP (0.25%) and isopropyl myristate (99.25%) on knockdown and mortality of the yellow fever mosquito, Aedes aegypti.

TABLE 1

| | | Time | | | |
|---|---|---|---|---|---|
| Insect Tested | Response | 5 min | 30 min | 1 hr | 2 hr |
| Yellow Fever | Knockdown | 100% | 100% | 100% | 100% |
| Mosquito | Mortality | 0% | 13% | 13% | 100% |

### Example 2

### Misting Efficacy of EcoExempt IC-2/EcoAdjuvant on House Fly (Musta Domestica)

EcoExempt IC-2 Ingredients (weight %):

ACTIVE INGREDIENTS:
Rosemary Oil (18.0%)
Cinnamon Oil (2.0%)
Lemongrass Oil (2.0%)

OTHER INGREDIENTS:
EcoAdjuvant (78.0%)
   EcoAdiuvant Ingredients (weight %)

Solvent (Benzyl Alcohol) (50%)

Surfactant (Tergitol TMN-6) (50%)

Methods—Adult house fly knockdown bioassay:

The EcoExempt IC-2+EcoAdjuvant combination was applied with (1) a “Hurricane ULV apparatus”, (2) “Delta” hand held trigger sprayer (3) an air brush system using identical application rates and (4) a thermal fogger using mineral oil as the solvent/carrier. Test containers and flies (˜10/rep) were thoroughly treated, but not to the point of run-off. Knockdown and mortality were assessed at designated times post-treatment. he follow table shows results obtained. Corrected mean percent knockdown mortality of EcoExempt IC-2 (9 oz/gal)+EcoAdjuvant (2 oz/gal) and EcoExempt IC-2 (9 oz/gal) in mineral oil (thermal fogger only) applied with designated application equipment against caged house flies, Musca domestica (ZCS Lab Strain) at designated times after treatment. (n=5)

| Treat- | | | | | | | | | |
|---|---|---|---|---|---|---|---|---|---|
| ment | | | | | | | | | |
| Equip- | 15 | 30 | 45 | 60 | 90 | 2 | 4 | 8 | 24 |
| ment | min | min | min | min | min | hours | hours | hours | hours |
| Hurri- | 0 | 1.8 | 19.6 | 35.7 | 48.2 | 67.8 | 100 | 100 | 100 |
| cane | | | | | | | | | |
| Delta | 72.7 | 83.6 | 87.3 | 92.7 | 94.5 | 100 | 100 | 100 | 100 |
| Sprayer | | | | | | | | | |
| Air | 0 | 0 | 0 | 0 | 0 | 0 | — | — | — |
| Brush | | | | | | | | | |
| Thermal | 0 | 0 | 0 | 0 | 0 | 0 | — | — | — |
| Fogger | | | | | | | | | |

Conclusion: The EcoExempt IC-2+EcoAdjuvant combination was effective as a knockdown agent against adult house flies when applied with equipment dispensing larger particle sizes such as the Delta and Hurricane sprayers (>50 micron).

### Example 3

### Efficacy of EcoExempt MC+EcoEmulsifier on Mosquitoes Using Various Commercially Available Misting Systems

EcoExempt MC Ingredients (weight %):

Rosemary oil—18%

Wintergreen oil—33%

Eugenol—10%

Thyme oil—2%

Lemongrass oil—2%

Cinnamon leaf oil—7%

Centrophase HR2B—3%

Isopropyl myristate—25%

EcoEmulsifier Ingredients (weight %):

Alkamuls EL-719—40%

Rhodapex CO-436—60%

### MISTINGSYSTEM 1

System Manufacturer Buzz Off Mosquito

Type of System: 55 gal. tank system

Timer Settings: 25 to 35 seconds Dawn Dusk Midnight

Phytotoxicity: None observed

Emulsion Stability Very stable no separation observed

Efficacy: Complete mosquito elimination at the above settings

### MISTINGSYSTEM 2

System Manufacturer Coastal Misters

Type of System: 55 gal. tank system

Timer Settings: 35 seconds Dawn Dusk Midnight

Phytotoxicity: None observed

Emulsion Stability Very stable no separation observed

Efficacy: Complete mosquito elimination at these settings

Note: This system was operating for 4 months with EcoExempt MC+EcoEmulsifler

### Mistingsystem 3

System Manufacturer Mosquito Max

Type of System: Tankless

Timer Settings: 35 to 35 seconds Dawn Dusk Midnight

Phytotoxicity: None observed

Emulsion Stability Very stable no separation observed

Efficacy: Complete mosquito elimination at these settings

Note: This system was operating for 5 months with EcoExempt MC+EcoEmulsifer With tankless systems, one-half the regular amount of EcoEmulsifier may be utilized.

### Misting System 4

System Manufacturer Integrated Pest Management

Type of System 55 gal. tank system

Timer Settings 25 to 45 seconds Dawn Dusk Midnight

Phytotoxicity None observed

Emulsion Stability Very stable no separation observed

Efficacy Complete mosquito elimination at these settings

Note: This system was operating for 4 months with EcoExempt MC+EcoEmulsifer

### Mistingsystem 5

System Manufacturer Monster Mosquito

Type of System: 55 gal. tank system

Timer Settings: 25 to 35 seconds Dawn Dusk Midnight

Phytotoxicity: None observed

Emulsion Stability Very stable no separation observed

Efficacy: Complete mosquito elimination at these settings

Note: This system was operating for 4 months with EcoExempt MC+EcoEmulsifer

### Mistingsystem 6

System Manufacturer Mosquito Pro

Type of System: 55 gal. tank system

Timer Settings: 35 seconds Dawn Dusk Midnight

Phytotoxicity: None observed

Emulsion Stability Very stable no separation observed

Efficacy: Complete mosquito elimination at these settings

Note: This system was operating for 4 months with EcoExempt MC+EcoEmulsifer

### Mistingsystem 7

System Manufacturer Coastal Misters

Type of System: Standard with 55 gallon tank

Timer Settings: 35 to 35 seconds Dawn Dusk Midnight

Phytotoxicity: None observed

Emulsion Stability Very stable no separation observed

Efficacy: Complete mosquito elimination at these settings

Note: This system was operating for 4 months with EcoExempt MC+EcoEmulsifer

### Mistingsystem 8

System Manufacturer Third Coast

Type of System: 55 gal. tank system

Timer Settings: 25 to 35 seconds Dawn Dusk Midnight

Phytotoxicity: None observed

Emulsion Stability Very stable no separation observed

Efficacy: Complete mosquito elimination at these settings

Note: This system was operating for 4 months with EcoExempt MC+EcoEmulsifler

As can be seen from the above discussion, the systems, methods and apparatuses for killing (or repelling) flying insects are markedly superior to known pesticidal agents/active compounds conventionally used systems, methods and apparatuses for killing (or repelling) flying insects. In sum, the invention encompasses at least:
A system for decreasing the number of pests (e.g., flying insects) within an area to be protected, the system comprising a pump for pumping a liquid pesticide formulation from a reservoir into a transmission line and pressurizing the liquid pesticide formulation within the transmission line, the transmission line having at least one atomizing assembly operably connected to the transmission line so that when the a liquid pesticide formulation is pressurized in the transmission line the liquid pesticide formulation is released from the atomizing assembly as an atomized mist.
The system is designed such that its components are durable and can withstand the aggressive nature of EPA exempt pesticide formulations, utilizing brass, stainless steel, Viton, PET, and other such materials.
The atomizing assembly may be comprised of a nozzle adapter and an atomizing nozzle operably connected to the nozzle adapter, wherein the nozzle adapter is operably connected to the transmission line.
The atomizing nozzle has an aperture from which the liquid pesticide formulation is released under pressure as an atomized mist.
The atomized mist produced by the system comprises droplets having an average size of less than 50 microns; an average size of about 10 microns to about 50 microns; an average size of from about 20 to about 50 microns; an average size of at least 50 microns; an average size of from about 50 to 100 microns or more; and all subranges therebetween.
The atomized mist comprises droplets having an average size of from about 2 to about 100 microns or more, and all subranges therebetween.
The system preferably comprises at least two atomizing assemblies.
The liquid pesticide formulation used in the system is a stable, single-phase atomizable liquid that comprises an EPA exempt active ingredient having pesticide activity.
The active ingredient may be a plant essential oil, an isolate of an essential oil, a derivative thereof, or a synthetic equivalent thereof, either alone or in combination as previously described above.
The emulsifier may be unique blends of solvents and surfactants that are able to emulsify the plant essential oils and maintain such emulsion for long periods of time under extreme temperatures.
In operation, the pump may cycle on and off by a controller that may be programmable, if desired.
Control of pests is achieved through mortality on contact up to 15 feet from misting system nozzles.
Control of pests is achieved through repellency from the treated area. Fly control can be achieved when droplet/particle size of not less than about 50 microns.

Although illustrative embodiments of the invention have been described in detail, it is to be understood that the invention is not limited to those precise embodiments, and that various changes and modifications can be effected therein by one skilled in the art without departing from the scope and spirit of the invention as defined herein. It is to be understood that each of the ranges recited above are intended to include all subranges therebetween.

What is claimed is:

1. A misting system comprising: a) a fluid reservoir for containing a pesticidal composition; b) a misting nozzle for dispersal of the pesticidal composition; c) a conduit for transmitting the pesticidal composition from the reservoir to the nozzle; and d) a pump for flowing the pesticidal composition through the conduit, wherein the pesticidal composition comprises a pesticidally acceptable carrier and at least one pesticidally active ingredient.

2. The misting system of claim 1, wherein the pesticidally active ingredient is selected from at least one member of the group consisting of: α-pinene or β-pinene; α-campholenic aldehyde; α-citronellol; α-iso-amyl-cinnamic (e.g., amyl cinnamic aldehyde); α-pinene oxide; α-cinnamic terpinene; α-terpineol (e.g., methods.1-methyl-4-isopropyl-1-cyclohexen-8-ol); λ-terpinene; achillea; aldehyde c16 (pure); alpha-phellandrene; amyl cinnamic aldehyde; amyl salicylate; anethole; anise; aniseed; anisic aldehyde; basil; bay; benzyl acetate; benzyl alcohol; bergamot (e.g., monardia fistulosa, monarda didyma, citrus bergamia, monarda punctata); beta-pinene; bitter orange peel; black pepper; black seed oil; borneol; calamus; camphene; camphor (e.g., camphor dextro); cananga oil (e.g., java); canola; cardamom; carnation (e.g., dianthus caryophyllus); carvacrol; carveol; cassia; castor; catnip; cedar (e.g., hinoki); cedarwood; chamomile; cineole; cinnamaldehyde; cinnamic alcohol; cinnamon (e.g., cinnamon leaf oil); cis-pinane; citral (e.g., 3,7-dimethyl-2,6-octadienal); citronella; citronellal; citronellol dextro (e.g., 3-7-dimethyl-6-octen-1-ol); citronellol; citronellyl acetate; citronellyl nitrile; citrus; citrus unshiu; clary sage; clove (e.g., eugenia caryophyllus); clove bud; coriander; corn; cotton seed; d-dihydrocarvone; decyl aldehyde; diethyl phthalate; dihydroanethole; dihydrocarveol; dihydrolinalool; dihydromyrcene; dihydromyrcenol; dihydromyrcenyl acetate; dihydroterpineol; dimethyl salicylate; dimethyloctanal; dimethyloctanol; dimethyloctanyl acetate; diphenyl oxide; dipropylene glycol; d-limonene; d-pulegone; estragole; ethyl vanillin (e.g., 3-ethoxy-4-hydrobenzaldehyde); eucalyptol (e.g., cineole); eucalyptus citriodora; eucalyptus globulus; eucalyptus; eugenol (e.g., 2-methoxy-4-allyl phenol); evening primrose; fenchol; fennel; Ferniol™; fish; florazon (e.g., 4-ethyl-α, α-dimethyl-benzenepropanal); galaxolide; garlic; geraniol (e.g., 2-trans-3,7-dimethyl-2,6-octadien-8-ol); geraniol; geraniol 60; geranium; geranyl acetate; geranyl nitrile; ginger; grapefruit; guaiacol; guaiacwood; gurjun balsam; hedione; heliotropin; herbanate (e.g., 3-(1-methyl-ethyl) bicyclo (2, 2, 1) hept-5-ene-2-carboxylic acid ethyl ester); hercolyn d; hiba; hydroxycitronellal; i-carvone; i-methyl acetate; ionone; isobutyl quinoleine (e.g., 6-secondary butyl quinoline); isobornyl acetate; isobornyl methylether; isoeugenol; isolongifolene; isosafrole; jasmine; jojoba; juniper berry; lavender; lavandin; lemongrass; lemon; lilac flower oil; lime; lime oil; limonene; linallol oxide; linallol; linalool; linalyl acetate; linseed; litsea cubeba; 1-methyl acetate; longifolene; mandarin; mentha; menthane hydroperoxide; menthol crystals; menthol laevo (e.g., 5-methyl-2-isopropyl cyclohexanol); menthol; menthone laevo (e.g., 4-isopropyl-1-methyl cyclohexan-3-one); methyl anthranilate; methyl cedryl ketone; methyl chavicol; methyl hexyl ether; methyl ionone; methyl salicylate; mineral; mint; musk ambrette; musk ketone; musk xylol; mustard (also known as allylisothio-cyanate); myrcene; neem; nerol; neryl acetate; nonyl aldehyde; nutmeg (e.g., myristica fragrans); orange (e.g., citrus aurantium dulcis); orris (e.g., iris florentina) root; para-cymene; para-hydroxy phenyl butanone crystals (e.g., 4-(4-hydroxyphenyl)-2-butanone); passion palmarosa oil (e.g., cymbopogon martini); patchouli (e.g., pogostemon cablin); p-cymene; pennyroyal; pepper; peppermint (e.g., mentha piperita); perillaldehyde; petitgrain (e.g., citrus aurantium amara); phenyl ethyl alcohol; phenyl ethyl propionate; 2-phenyl ethyl propionate; phenyl ethyl-2-methylbutyrate; pimento berry; pimento leaf; pinane hydroperoxide; pinanol; pine ester; pine needle; pine; pinene; piperonal; piperonyl acetate; piperonyl alcohol; plinol; plinyl acetate; pseudo ionone; rhodinol; rhodinyl acetate; rosalin; rose; rosemary (e.g., rosmarinus officinalis); ryu; safrole; sage; sandalwood (e.g., santalum album); sandenol; sassafras; sesame; soy; soybean; spearmint; spice; spike lavender; spirantol; starflower; tangerine; tea seed; tea tree; terpenoids (isoprenoids or terpenes); terpineol; terpinene-4-ol; terpinolene; terpinyl acetate; tert-butylcyclohexyl acetate; tetrahydrolinalool; tetrahydrolinalyl acetate; tetrahydromyrcenol; thulasi; thyme; thymol; tomato; trans-2-hexenol; trans-anethole and metabolites thereof; triethyl citrate; turmeric; turpentine; vanillin (e.g., 4-hydroxy-3-methoxy benzaldehyde); vetiver; vitalizair; white cedar; white grapefruit; and wintergreen (e.g., betula oil).

3. The misting system of claim 1, wherein the pesticidally acceptable carrier is selected from at least one member of the group consisting of: polysorbate 20; mono-glyceride derivatives; poly-oxyethylene nonyl phenolethers; sugars; esters; sodium lauryl sulfate (SLS); butyl lactate; isopropyl myristate (and analogs thereof); sorbitol, lecithin; sorbitan monooleate; benzyl alcohol; tergitol; sodium alkyl ether sulfate; and the like.

4. The misting system of claim 2, wherein the pesticidally active ingredient is at least one member selected from the group consisting of rosemary, wintergreen, lemongrass, thyme, eugenol, cinnamon, geraniol, peppermint, vanillin and sesame.

5. The misting system of claim 2, wherein the pesticidally active ingredient consists of rosemary and wintergreen;

6. The misting system of claim 2, wherein the pesticidally active ingredient consists of rosemary, peppermint and wintergreen;

7. The misting system of claim 2, wherein the pesticidally active ingredient consists of eugenol and phenyl ethyl propionate;

8. The misting system of claim 2, wherein the pesticidally active ingredient consists of eugenol, phenyl ethyl propionate and isopropyl myristate;

9. The misting system of claim 2, wherein the pesticidally active ingredient consists of rosemary, wintergreen, lemongrass, cinnamon, and isopropyl myristate.

10. The misting system of claim 1, wherein the pesticidal composition comprises: cinnamon; eugenol; isopropyl alcohol; isopropyl myristate; lemongrass; peppermint; thyme; and vanillin.

11. The misting system of claim 1, wherein the pesticidal composition comprises: cinnamon; clove; isopropyl myristate; lemongrass; peppermint; thyme; and vanillin.

12. The misting system of claim 1, wherein the pesticidal composition comprises: peppermint; rosemary; vanillin; and wintergreen oil.

13. The misting system of claim 1, wherein the pesticidal composition comprises: cinnamon; eugenol; lecithin; lemongrass; rosemary; thyme; and wintergreen oil.

14. The misting system of claim 1, wherein the pesticidal composition comprises: eugenol; isopropyl myristate; lecithin; mineral; phenyl ethyl propionate; sodium lauryl sulfate; and wintergreen oil.

15. The misting system of claim 1, wherein the pesticidal composition comprises: clove; lecithin; and wintergreen oil.

16. The misting system of claim 1, wherein the pesticidal composition comprises: clove; lecithin; rosemary; thyme; and wintergreen oil.

17. The misting system of claim 1, wherein the pesticidal composition comprises: eugenol; lecithin; rosemary; sodium lauryl sulfate; thyme; and wintergreen oil.

18. The misting system of claim 1, wherein the pesticidal composition comprises: lecithin; peppermint; rosemary; sodium lauryl sulfate; vanillin; and wintergreen oil.

19. The misting system of claim 1, wherein the pesticidal composition comprises: lecithin; mineral; peppermint; rosemary; sodium lauryl sulfate; vanillin; and wintergreen oil.

20. The misting system of claim 1, wherein the pesticidal composition comprises: cinnamon; lecithin; lemongrass; mineral; peppermint; phenyl ethyl propionate; sodium lauryl sulfate; thyme; vanillin; and wintergreen oil.

21. The misting system of claim 1, wherein the pesticidal composition comprises: cinnamon; geraniol; lemongrass; peppermint; phenyl ethyl propionate; sesame; vanillin; and wintergreen oil.

22. The misting system of claim 1, wherein the pesticidal composition comprises: cinnamon; geraniol; lecithin; lemongrass; mineral; peppermint; rosemary; sodium lauryl sulfate; thyme; vanillin; and wintergreen oil.

23. The misting system of claim 1, wherein the pesticidal composition comprises: eugenol; glacial acetic acid; hydroxypropylcellulose; lecithin; phenyl ethyl propionate; and sodium lauryl sulfate.

24. The misting system of claim 1, wherein the pesticidal composition comprises: cinnamon; eugenol; lecithin; lemongrass; rosemary; thyme; and wintergreen oil.

25. The misting system of claim 1, wherein the pesticidal composition comprises: cinnamon; geraniol; lecithin; lemongrass; peppermint; rosemary; sodium lauryl sulfate; vanillin; and wintergreen oil.

26. The misting system of claim 1, wherein the pesticidal composition comprises: lecithin; mineral; rosemary; sodium lauryl sulfate; and wintergreen oil.

27. The misting system of claim 1, wherein the pesticidal composition comprises: eugenol; glacial acetic acid; lecithin; sodium lauryl sulfate; and wintergreen oil.

28. The misting system of claim 1, wherein the pesticidal composition comprises: clove; glacial acetic acid; lecithin; and wintergreen oil.

29. The misting system of claim 1, wherein the pesticidal composition comprises: geraniol; peppermint; phenyl ethyl propionate (pep); propellant; sesame; vanillin; and wintergreen oil.

30. The misting system of claim 1, wherein the pesticidal composition comprises: peppermint; rosemary; vanillin; and wintergreen oil.

32. The misting system of claim 1, wherein the pesticidal composition comprises: mineral; rosemary; wintergreen; peppermint; and vanillin.
